(19) United States
(12) Patent Application Publication
(10) Pub. No.: US 2024/0178442 A1
(43) Pub. Date: May 30, 2024

(54) FLUORIDE ION CONDUCTIVE MATERIAL AND FLUORIDE SHUTTLE BATTERY

(71) Applicant: Panasonic Holdings Corporation, Osaka (JP)

(72) Inventors: REIKO HINOGAMI, Osaka (JP); SHINJI TAMURA, Osaka (JP); NOBUHITO IMANAKA, Hyogo (JP)

(21) Appl. No.: 18/393,699

(22) Filed: Dec. 22, 2023

Related U.S. Application Data
(63) Continuation of application No. PCT/JP2022/025009, filed on Jun. 23, 2022.

(30) Foreign Application Priority Data
Jul. 15, 2021 (JP) 2021-117454

(51) Int. Cl. H01M 10/0562

(52) U.S. Cl. CPC H01M 10/0562; H01M 2300/008

(57) ABSTRACT

A fluoride ion conductive material includes a compound containing fluorine element, lanthanum element, an alkaline earth metal element, and an alkali metal element. The compound is represented by La_{1-x-y}M1ₓM2_{y}F_{3-x-2y} wherein M1 is at least one element selected from alkaline earth metal elements, M2 is at least one element selected from alkali metal elements, x satisfies 0<x≤0.3, y satisfies 0<y≤0.2, and x+y satisfies 0<x+y≤0.4.

### BACKGROUND

### 1. Technical Field

The present disclosure relates to a fluoride ion conductive material and a fluoride shuttle battery.

### 2. Description of the Related Art

Lithium-ion secondary batteries are secondary batteries with high energy density that are widespread. Furthermore, lithium-ion all-solid-state batteries using a nonflammable inorganic solid electrolyte have been proposed and have been extensively researched and developed because of their high safety. Fluoride ion batteries using the shuttle of fluoride ions (F⁻) have been proposed as a type of batteries using such a solid electrolyte. Fluoride ion batteries have high theoretical energy density.

Among solid electrolytes usable in fluoride ion secondary batteries, for example, LA₁₋ₓAEₓF₃₋ₓ that are tysonite compounds doped with an alkaline earth metal (J. Mat. Chem., 2011, 21, 17059), and fluorite compounds Ca_{1-y}Ba_{y}F₂ (Dalton Trans., 2018, 47, 4105-4117) are reported as having relatively high fluoride ionic conductivity and a wide potential window. In LA₁₋ₓAEₓF₃₋ₓ, x is greater than or equal to 0.01 and less than or equal to 0.2; “LA” indicates a rare earth metal, such as La or Ce; and “AE” indicates an alkaline earth metal, such as Ca, Sr, or Ba. In the fluorite compounds Ca_{1-y}Ba_{y}F₂, y is greater than or equal to 0.1 and less than or equal to 0.9. Furthermore, Japanese Unexamined Patent Application Publication No. 2019-16426 discloses that a fluoride ion conductive material containing lanthanum fluoride and strontium fluoride may be used in fluoride shuttle batteries.

### SUMMARY

In one general aspect, the techniques disclosed here feature a fluoride ion conductive material including a compound containing fluorine element, lanthanum element, an alkaline earth metal element, and an alkali metal element. The compound is represented by La_{1-x-y}M1ₓM2_{y}F_{3-x-2y} wherein M1 is at least one element selected from alkaline earth metal elements, M2 is at least one element selected from alkali metal elements, x satisfies 0<x≤0.3, y satisfies 0<y≤0.2, and x+y satisfies 0<x+y≤0.4.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view schematically illustrating a fluoride shuttle battery according to an embodiment of the present disclosure; and

FIG. 2 is a graph illustrating results of a charge/discharge test of an evaluation cell of EXAMPLE 4.

### DETAILED DESCRIPTIONS

### Underlying Knowledge Forming Basis of the Present Disclosure

The fluoride ion conductive material of Japanese Unexamined Patent Application Publication No. 2019-16426 described in “Description of the Related Art” is lanthanum fluoride doped with alkaline earth metal Sr. Japanese Unexamined Patent Application Publication No. 2019-16426 discloses that the fluoride ion conductive material has high fluoride ion conductivity at a high temperature of 140° C. The desired performance, however, is that a fluoride ion conductive material exhibits high fluoride ion conductivity near room temperature at which practical batteries are operated. Thus, the present inventors carried out extensive studies and have completed a novel fluoride ion conductive material that exhibits high fluoride ion conductivity, for example, at or around room temperature.

### Summary of Aspects of the Present Disclosure

A fluoride ion conductive material according to the first aspect of the present disclosure includes a compound containing fluorine element, lanthanum element, an alkaline earth metal element, and an alkali metal element, the compound being represented by the compositional formula (1) below:

La_{1-x-y}M1ₓM2_{y}F_{3-x-2y} (1)
wherein
M1 is at least one element selected from alkaline earth metal elements,
M2 is at least one element selected from alkali metal elements,
x satisfies 0<x≤0.3,
y satisfies 0<y≤0.2, and
x+y satisfies 0<x+y≤0.4.

The fluoride ion conductive material according to the first aspect is a novel fluoride ion conductive material having fluoride ion conductivity. For example, the fluoride ion conductive material according to the first aspect can exhibit high fluoride ionic conductivity even at room temperature (for example, 25° C.). Lanthanum fluoride doped with alkaline earth metal Sr is known as a fluoride ion conductive material. This conventional material exhibits high conductivity near 140° C., but the conductivity is insufficient at room temperature. In contrast, the fluoride ion conductive material according to the first aspect attains enhanced conductivity as a result of the incorporation of a monovalent alkali metal in addition to a divalent alkaline earth metal and the consequent increase in the concentration of fluorine vacancies in the lanthanum fluoride crystal.

In the second aspect of the present disclosure, for example, in the fluoride ion conductive material according to the first aspect, x may satisfy 0<x≤0.1.

The fluoride ion conductive material according to the second aspect exhibits still enhanced fluoride ionic conductivity.

In the third aspect of the present disclosure, for example, in the fluoride ion conductive material according to the first or the second aspect, y may satisfy 0<y≤0.1.

The fluoride ion conductive material according to the third aspect exhibits still enhanced fluoride ionic conductivity.

In the fourth aspect of the present disclosure, for example, in the fluoride ion conductive material according to any one of the first to the third aspects, M1 may include Sr and M2 may include Na.

The fluoride ion conductive material according to the fourth aspect exhibits still enhanced fluoride ionic conductivity.

In the fifth aspect of the present disclosure, for example, in the fluoride ion conductive material according to the fourth aspect,
the compositional formula (1) may be:

La_{1-x-y}SrₓNa_{y}F_{3-x-2y}
and
x may satisfy 0<x≤0.05.

The fluoride ion conductive material according to the fifth aspect exhibits still enhanced fluoride ionic conductivity.

In the sixth aspect of the present disclosure, for example, in the fluoride ion conductive material according to the fifth aspect, y may satisfy 0<y≤0.04.

The fluoride ion conductive material according to the sixth aspect exhibits still enhanced fluoride ionic conductivity.

In the seventh aspect of the present disclosure, for example, in the fluoride ion conductive material according to any one of the first to the third aspects, M1 may include Ba and M2 may include Na.

The fluoride ion conductive material according to the seventh aspect exhibits still enhanced fluoride ionic conductivity.

In the eighth aspect of the present disclosure, for example, in the fluoride ion conductive material according to the seventh aspect,
the compositional formula (1) may be:

La_{1-x-y}BaₓNa_{y}F_{3-x-2y}
and
x may satisfy 0<x≤0.05.

The fluoride ion conductive material according to the eighth aspect exhibits still enhanced fluoride ionic conductivity.

In the ninth aspect of the present disclosure, for example, in the fluoride ion conductive material according to the eighth aspect, y may satisfy 0<y≤0.04.

The fluoride ion conductive material according to the ninth aspect exhibits still enhanced fluoride ionic conductivity.

In the tenth aspect of the present disclosure, for example, in the fluoride ion conductive material according to any one of the first to the third aspects, M1 may include Ca and M2 may include K.

The fluoride ion conductive material according to the tenth aspect exhibits still enhanced fluoride ionic conductivity.

In the eleventh aspect of the present disclosure, for example, in the fluoride ion conductive material according to the tenth aspect,
the compositional formula (1) may be:

La_{1-x-y}CaₓK_{y}F_{3-x-2y}
and
x may satisfy 0<x≤0.05.

The fluoride ion conductive material according to the eleventh aspect exhibits still enhanced fluoride ionic conductivity.

In the twelfth aspect of the present disclosure, for example, in the fluoride ion conductive material according to the eleventh aspect, y may satisfy 0<y≤0.02.

The fluoride ion conductive material according to the twelfth aspect exhibits still enhanced fluoride ionic conductivity.

A fluoride shuttle battery according to the thirteenth aspect of the present disclosure includes:
a positive electrode;
a negative electrode; and
an electrolyte layer disposed between the positive electrode and the negative electrode, wherein
at least one selected from the group consisting of the positive electrode, the negative electrode, and the electrolyte layer includes the fluoride ion conductive material according to any one of the first to the twelfth aspects.

The fluoride shuttle battery according to the thirteenth aspect is operable at room temperature.

### Embodiments of the Present Disclosure

Hereinafter, embodiments of the present disclosure will be described in detail with reference to the drawings.

### Fluoride Ion Conductive Materials

A fluoride ion conductive material according to an embodiment of the present disclosure includes a compound that contains fluorine element, lanthanum element, an alkaline earth metal element, and an alkali metal element.

The fluoride ion conductive material according to the present embodiment can exhibit high fluoride ion conductivity even at room temperature (for example, 25° C.). Thus, the fluoride ion conductive material according to the present embodiment may be used in a fluoride shuttle battery to enable the battery to operate at room temperature.

The fluoride ion conductive material according to the present embodiment may consist essentially of a compound containing fluorine element, lanthanum element, an alkaline earth metal element, and an alkali metal element. Here, the phrase “the fluoride ion conductive material consists essentially of a compound containing fluorine element, lanthanum element, an alkaline earth metal element, and an alkali metal element” means that the fluoride ion conductive material according to the present embodiment contains greater than or equal to 70 mol % of the compound containing fluorine element, lanthanum element, an alkaline earth metal element, and an alkali metal element. In the fluoride ion conductive material according to the present embodiment, the content of the compound containing fluorine element, lanthanum element, an alkaline earth metal element, and an alkali metal element may be greater than or equal to 80 mol % or may be greater than or equal to 90 mol %.

In order to attain an increased fluoride ionic conductivity, the fluoride ion conductive material according to the present embodiment may consist solely of a compound containing fluorine element, lanthanum element, an alkaline earth metal element, and an alkali metal element.

The compound containing fluorine element, lanthanum element, an alkaline earth metal element, and an alkali metal element is represented by the following compositional formula (1):

La_{1-x-y}M1ₓM2_{y}F_{3-x-2y} (1)

In the compositional formula (1),
M1 is at least one element selected from alkaline earth metal elements,
M2 is at least one element selected from alkali metal elements,
x satisfies 0<x≤0.3,
y satisfies 0<y≤0.2, and
x+y satisfies 0<x+y≤0.4.

In order to attain an increased fluoride ionic conductivity, x in the compositional formula (1) may satisfy 0<x≤0.1, may satisfy 0<x≤0.07, may satisfy 0<x≤0.06, or may satisfy 0<x≤0.05.

In order to attain an increased fluoride ionic conductivity, y in the compositional formula (1) may satisfy 0<y≤0.1, may satisfy 0<y≤0.05, may satisfy 0<y≤0.04, may satisfy 0<y≤0.03, or may satisfy 0<y≤0.02.

In order to attain an increased fluoride ionic conductivity, the total of the amounts of substance of the alkaline earth metal element(s) and the alkali metal element(s) relative to the amount of substance of La may be less than or equal to 0.7, may be less than or equal to 0.5, may be less than or equal to 0.3, or may be less than or equal to 0.1. That is, the molar ratio of the total of the alkaline earth metal element(s) and the alkali metal element(s) to La may be less than or equal to 0.7, may be less than or equal to 0.5, may be less than or equal to 0.3, or may be less than or equal to 0.1.

In order to attain an increased fluoride ionic conductivity, the compositional formula (1) may be such that M1 includes Sr and M2 includes Na. In order to attain a further increased fluoride ionic conductivity, for example, the compositional formula (1) may be La_{1-x-y}SrₓNa_{y}F_{3-x-2y}. In this case, x may satisfy 0<x≤0.05. Furthermore, in the above case, y may satisfy 0<y≤0.04.

In order to attain an increased fluoride ionic conductivity, the compositional formula (1) may be such that M1 includes Ba and M2 includes Na. In order to attain a further increased fluoride ionic conductivity, for example, the compositional formula (1) may be La_{1-x-y}BaₓNa_{y}F_{3-x-2y}. In this case, x may satisfy 0<x≤0.05. Furthermore, in the above case, y may satisfy 0<y≤0.04.

In order to attain an increased fluoride ionic conductivity, the compositional formula (1) may be such that M1 includes Ca and M2 includes K. In order to attain a further increased fluoride ionic conductivity, for example, the compositional formula (1) may be La_{1-x-y}CaₓK_{y}F_{3-x-2y}. In this case, x may satisfy 0<x≤0.05. Furthermore, in the above case, y may satisfy 0<y≤0.02.

For example, the fluoride ion conductive material according to the present embodiment is produced by the following method.

Ingredient powders are mixed so that the target composition will be obtained. Examples of the ingredient powders include lanthanum fluoride, alkaline earth metal fluorides, and alkali metal fluorides or carbonates. Ingredients other than those described above may be used as long as the constituent elements include lanthanum, an alkaline earth metal, an alkali metal, and fluorine. The ingredient powders that are used may be those that are powdered with a pulverizer, such as a ball mill or a rod mill. The mixture obtained (namely, a precursor of the fluoride ion conductive material) is heat-treated at a temperature of, for example, 500° C. to 1200° C. A fluoride ion conductive material according to the present embodiment may be thus obtained. For example, NH₄F may be added when the precursor is heat-treated. For example, NH₄F may be admixed with the precursor, and the resultant mixture may be heat-treated. The addition of NH₄F at the heat treatment of the precursor can suppress oxidation or decomposition of the fluoride ion conductive material during the heat treatment.

### Fluoride Shuttle Batteries

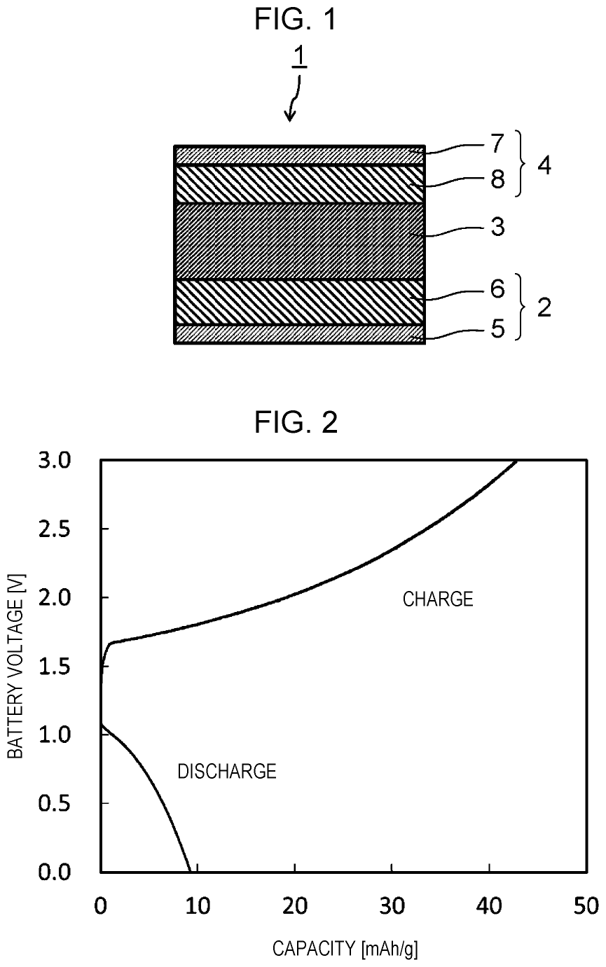

FIG. 1 is a sectional view schematically illustrating a fluoride shuttle battery according to an embodiment of the present disclosure. The fluoride shuttle battery 1 illustrated in FIG. 1 includes a positive electrode 2, an electrolyte layer 3, and a negative electrode 4. At least one selected from the group consisting of the positive electrode 2, the negative electrode 4, and the electrolyte layer 3 includes the fluoride ion conductive material according to the embodiment described above. As described hereinabove, the fluoride ion conductive material according to the embodiment described above can exhibit high fluoride ion conductivity at room temperature. Thus, the fluoride shuttle battery according to the present embodiment that includes the fluoride ion conductive material is operable at, for example, room temperature.

The electrolyte layer 3 is disposed between the positive electrode 2 and the negative electrode 4. For example, the positive electrode 2 includes a positive electrode current collector 5 and a positive electrode active material layer 6. For example, the negative electrode 4 includes a negative electrode current collector 7 and a negative electrode active material layer 8.

The positive electrode active material layer 6 includes a positive electrode active material. The positive electrode active material is a material that can absorb and desorb fluoride ions when the fluoride shuttle battery 1 is charged and discharged. The absorption and desorption of fluoride ions may be chemical reactions or may occur without chemical reactions, for example, intercalation. The chemical reactions may form compounds or may form composites that are not compounds, such as alloys or solid solutions.

The positive electrode active material may be a material that has a standard electrode potential more positive than a negative electrode active material paired with the positive electrode active material in the fluoride shuttle battery 1.

For example, the positive electrode active material layer 6 in the positive electrode 2 may include a positive electrode active material including a first metal element, and a first solid electrolyte. In this case, the first solid electrolyte may be the fluoride ion conductive material according to the embodiment described hereinabove.

By virtue of the positive electrode 2 having the above configuration, the fluoride shuttle battery 1 can attain enhanced charge/discharge capacities.

For example, the first metal element may be at least one element selected from the group consisting of Cu, Bi, Pb, Sb, Fe, Zn, Ni, Mn, Sn, Ag, Cr, In, Ti, and Co. In the positive electrode 2, the first metal element may be an elemental metal, a composite, such as an alloy or a solid solution, or a compound. For example, the compound of the first metal element is a fluoride. The fluoride shuttle battery 1 that includes the positive electrode 2 containing such a first metal element can attain enhanced charge/discharge capacities.

The first metal element may be at least one selected from the group consisting of Cu and Ag. In this case, the fluoride shuttle battery 1 can attain further enhanced charge/discharge capacities.

For example, the thickness of the positive electrode active material layer 6 is 1 to 500 μm. The thickness of the positive electrode active material layer 6 may be 1 to 400 μm or may be 50 to 200 μm. When the thickness of the positive electrode active material layer 6 is in the above ranges, the fluoride shuttle battery 1 can attain further enhancements in energy density and can be operated more stably at high output.

The negative electrode active material layer 8 includes a negative electrode active material. The negative electrode active material is a material that can absorb and desorb fluoride ions when the battery is charged and discharged. The absorption and desorption of fluoride ions may be chemical reactions or may occur without chemical reactions, for example, intercalation. The chemical reactions may form compounds or may form composites that are not compounds, such as alloys or solid solutions.

The negative electrode active material may be a material that has a standard electrode potential more negative than the positive electrode active material paired with the negative electrode active material in the fluoride shuttle battery 1.

For example, the negative electrode active material layer 8 in the negative electrode 4 may include a negative electrode active material including a second metal element, and a second solid electrolyte. In this case, the second solid electrolyte may be the fluoride ion conductive material according to the embodiment described hereinabove.

By virtue of the negative electrode 4 having the above configuration, the fluoride shuttle battery 1 can attain enhanced charge/discharge capacities.

For example, the second metal element may be at least one element selected from the group consisting of Pb, Fe, Zn, Mn, Sn, Cr, In, Ti, Co, Al, Zr, La, Ba, Ca, Ce, and Sr. In the negative electrode 4, the second metal element may be an elemental metal, a composite, such as an alloy or a solid solution, or a compound. For example, the compound of the second metal element is a fluoride. The fluoride shuttle battery 1 that includes the negative electrode 4 containing such a second metal element can attain enhanced charge/discharge capacities.

In the negative electrode active material, the second metal element may be at least one selected from the group consisting of lead and tin. For example, the negative electrode active material may include Pb₁₋ₐSnₐF₂. Here, for example, a may satisfy 0≤a≤1 or may satisfy 0<a<1. When the second metal element is at least one selected from the group consisting of lead and tin, the fluoride shuttle battery 1 can attain further enhancements in charge/discharge capacities.

For example, the thickness of the negative electrode active material layer 8 is 1 to 500 μm. The thickness of the negative electrode active material layer 8 may be 1 to 400 μm or may be 30 to 200 μm. When the thickness of the negative electrode active material layer 8 is in the above ranges, the fluoride shuttle battery 1 can attain further enhancements in energy density and can be operated more stably at high output.

In the positive electrode 2, for example, the positive electrode active material layer 6 may include a conductive assistant. Furthermore, in the negative electrode 4, for example, the negative electrode active material layer 8 may include a conductive assistant. The addition of a conductive assistant may reduce the resistance of the positive electrode 2 and the negative electrode 4.

The conductive assistant is not limited as long as having electron conductivity. Examples of the conductive auxiliaries include graphites, such as natural graphite and artificial graphite; carbon blacks, such as acetylene black and Ketjen black; conductive fibers, such as carbon fibers and metal fibers; carbon fluoride; metal powders, such as aluminum; conductive whiskers, such as zinc oxide and potassium titanate; conductive metal oxides, such as titanium oxide; and conductive polymer compounds, such as polyaniline, polypyrrole, and polythiophene. The cost of the fluoride shuttle battery 1 may be reduced by using carbonous conductive auxiliaries, such as graphites and carbon blacks.

The positive electrode current collector 5 and the negative electrode current collector 7 have electron conductivity. The positive electrode current collector 5 and the negative electrode current collector 7 may be composed of materials that have electron conductivity and are resistant to corrosion under environments in which the fluoride shuttle battery 1 is charged and discharged.

For example, the positive electrode current collector 5 is composed of a metal material, such as aluminum, gold, platinum, or an alloy thereof. The shape of the positive electrode current collector 5 is not limited and is, for example, a sheet or a film. The positive electrode current collector 5 may be a porous or non-porous sheet or film. The sheets and films may be foils and meshes. Aluminum and alloys thereof are inexpensive and easily thinned. The positive electrode current collector 5 may be composed of carbon-coated aluminum. For example, the thickness of the positive electrode current collector 5 is 1 to 30 μm. When the thickness of the positive electrode current collector 5 is in this range, the strength of the current collector may be ensured more reliably and, for example, the current collector resists cracking and rupture, and further the energy density of the fluoride shuttle battery 1 may be ensured more reliably.

The positive electrode current collector 5 may have a positive electrode terminal.

For example, the negative electrode current collector 7 is composed of a metal material, such as gold, platinum, aluminum, or an alloy thereof. The shape of the negative electrode current collector 7 is not limited and is, for example, a sheet or a film. The negative electrode current collector 7 may be a porous or non-porous sheet or film. The sheets and films may be foils and meshes. Aluminum and alloys thereof are inexpensive and easily thinned. The negative electrode current collector 7 may be composed of carbon-coated aluminum. For example, the thickness of the negative electrode current collector 7 is 1 to 30 μm. When the thickness of the negative electrode current collector 7 is in this range, the strength of the current collector may be ensured more reliably and, for example, the current collector resists cracking and rupture, and further the energy density of the fluoride shuttle battery 1 may be ensured more reliably.

The electrolyte layer 3 is a layer that conducts fluoride ions in the thickness direction, that is, in the direction in which the positive electrode 2 and the negative electrode 4 are stacked. Typically, the electrolyte layer 3 does not have electron conductivity in the thickness direction. For example, the thickness of the electrolyte layer 3 is 1 to 1000 μm. The thickness of the electrolyte layer 3 may be 200 to 800 μm or may be 300 to 700 μm. The electrolyte layer 3 having a thickness in the above ranges suppresses electrical short-circuiting between the positive electrode 2 and the negative electrode 4 and more reliably exhibits fluoride ion conductivity. The realization of more reliable fluoride ion conductivity enables the fluoride shuttle battery 1 to attain higher output characteristics.

The electrolyte layer 3 may include a third solid electrolyte. In this case, the third solid electrolyte may be the fluoride ion conductive material according to the embodiment described hereinabove.

When the electrolyte layer 3 has the above configuration, the fluoride shuttle battery 1 can attain enhancements in charge/discharge capacities.

The electrolyte layer 3 may include a material other than the fluoride ion conductive material.

When any of the layers includes a particulate material, the layer may further include a binder that binds the particles together. The binder can enhance the integrity of the particles in the layer. Furthermore, the binder can enhance joint properties (bond strength) with respect to an adjacent layer. When, for example, the positive electrode active material layer 6 or the negative electrode active material layer 8 includes a particulate material, the addition of a binder to the active material layer can enhance joint properties between the active material layer and the current collector layer 5 or 7 adjacent to the active material layer. This enhancement in joint properties contributes to thinning of the layers because, for example, particles of the electrode active material can be brought into contact with one another more reliably in the positive electrode active material layer 6 and the negative electrode active material layer 8, and the electrolyte particles can be brought into contact with one another more reliably in the electrolyte layer 3. Thinning of the layers makes it possible to further enhance the energy density of the fluoride shuttle battery 1.

The binder is not limited. For example, the binder may be a binder composed of a fluororesin or may be a polymer compound or a rubbery polymer. Examples of the fluororesins forming the binders include polyvinylidene fluoride (PVdF), polytetrafluoroethylene (PTFE), tetrafluoroethylene-hexafluoropropylene copolymer (FEP), tetrafluoroethylene-hexafluoroethylene copolymer, Teflon (registered trademark) binder, poly(vinylidene fluoride), tetrafluoroethylene-perfluoroalkyl vinyl ether copolymers (PFA), vinylidene fluoride-hexafluoropropylene copolymer, vinylidene fluoride-chlorotrifluoroethylene copolymer, ethylene-tetrafluoroethylene copolymer (ETFE), polychlorotrifluoroethylene (PCTFE), vinylidene fluoride-hexafluoropropylene-tetrafluoroethylene copolymer, vinylidene fluoride-perfluoromethyl vinyl ether-tetrafluoroethylene copolymer, and ethylene-chlorotrifluoroethylene copolymer (ECTFE). Examples of the polymer compounds include carboxymethylcellulose, polyacrylonitrile, polyethylene oxide, polypropylene oxide, polyvinyl chloride, polymethyl methacrylate, polymethyl acrylate, polymethacrylic acid, polyacrylic acid, polyvinyl alcohol, polyvinylidene chloride, polyethyleneimine, polymethacrylonitrile, polyvinyl acetate, polyimide, polyamic acid, polyamideimide, polyethylene, polypropylene, ethylene-propylene-diene terpolymer, polyvinyl acetate, nitrocellulose, ethylene-acrylic acid copolymer, ethylene-methacrylic acid copolymer, ethylene-methyl acrylate copolymer, ethylene-methyl methacrylate copolymer, polyester resins, monoalkyltrialkoxysilane polymers, and copolymers of monoalkyltrialkoxysilane polymers with tetraalkoxysilane monomers. Examples of the rubbery polymers include styrene-butadiene rubber (SBR), butadiene rubber (BR), styrene-isoprene copolymer, isobutylene-isoprene copolymer (butyl rubber), acrylonitrile-butadiene rubber, ethylene-propylene-diene copolymer, acrylonitrile-butadiene copolymer (NBR), hydrogenated SBR, hydrogenated NBR, ethylene-propylene-dienemer (EPDM), and sulfonated EPDM.

When the binder is an insulating material that does not conduct fluoride ions and/or electrons and is present in an excessively high content in each layer, charge/discharge characteristics of the battery may be lowered or the energy density may be reduced after all. From this point of view, the content of an insulating binder in the layer is, for example, less than or equal to 20 mass %, and may be less than or equal to 5 mass %.

The binder may have fluoride ion conductivity. Examples of the fluoride ion conductive binders include ion conductive polymers doped with metal fluorides. The fluoride ion conductive binders offer enhanced fluoride ion conductivity compared to insulating binders and are expected to enhance charge/discharge characteristics and the energy density.

### EXAMPLES

The present disclosure will be described in greater detail below based on EXAMPLES. The following EXAMPLES are only illustrative and are not limiting.

### Example 1-1

### Preparation of Fluoride Ion Conductive Material

Powders of LaF₃ (manufactured by Kojundo Chemical Lab. Co., Ltd.), SrF₂ (manufactured by FUJIFILM Wako Pure Chemical Corporation), and Na₂CO₃ (manufactured by FUJIFILM Wako Pure Chemical Corporation) were mixed in a molar ratio of LaF₃:SrF₂:Na₂CO₃=95:3:1. Next, the mixture obtained was milled using a planetary ball mill for 5 hours. The milled mixture was heat-treated at 800° C. under a stream of argon gas containing 2 vol % hydrogen. A fluoride ion conductive material having a composition represented by the formula La_{0.95}Sr_{0.03}Na_{0.02}F_{2.93} was thus obtained.

### Evaluation of Fluoride Ionic Conductivity

The fluoride ionic conductivity of the fluoride ion conductive material was evaluated as follows. The fluoride ion conductive material was compressed into a pellet and was sintered at 1000° ° C. for 6 hours under a stream of argon gas. A Pt film was sputtered on the surface of the sintered body. An evaluation cell was thus formed. The measurement environment was an argon atmosphere at 25° C. A complex impedance method was used for the measurement of ionic conductivity. The fluoride ionic conductivity of the material prepared is described in Table 1 later.

### Example 1-2

In EXAMPLE 1-2, powders of LaF₃, SrF₂, and Na₂CO₃ were mixed in a molar ratio of LaF₃:SrF₂:Na₂CO₃=96:3:0.5. A fluoride ion conductive material of EXAMPLE 1-2 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-3

In EXAMPLE 1-3, powders of LaF₃, SrF₂, and Na₂CO₃ were mixed in a molar ratio of LaF₃:SrF₂:Na₂CO₃=95.5:3:0.75. A fluoride ion conductive material of EXAMPLE 1-3 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-4

In EXAMPLE 1-4, powders of LaF₃, SrF₂, and Na₂CO₃ were mixed in a molar ratio of LaF₃:SrF₂:Na₂CO₃=94.5:3:1.25. A fluoride ion conductive material of EXAMPLE 1-4 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-5

In EXAMPLE 1-5, powders of LaF₃, SrF₂, and Na₂CO₃ were mixed in a molar ratio of LaF₃:SrF₂:Na₂CO₃=94:3:1.5. A fluoride ion conductive material of EXAMPLE 1-5 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-6

In EXAMPLE 1-6, powders of LaF₃, SrF₂, and Na₂CO₃ were mixed in a molar ratio of LaF₃:SrF₂:Na₂CO₃=95:4:0.5. A fluoride ion conductive material of EXAMPLE 1-6 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-7

In EXAMPLE 1-7, powders of LaF₃, SrF₂, and Na₂CO₃ were mixed in a molar ratio of LaF₃:SrF₂:Na₂CO₃=94.5:4:0.75. A fluoride ion conductive material of EXAMPLE 1-7 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-8

In EXAMPLE 1-8, powders of LaF₃, SrF₂, and Na₂CO₃ were mixed in a molar ratio of LaF₃:SrF₂:Na₂CO₃=94:4:1. A fluoride ion conductive material of EXAMPLE 1-8 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-9

In EXAMPLE 1-9, powders of LaF₃, SrF₂, and Na₂CO₃ were mixed in a molar ratio of LaF₃:SrF₂:Na₂CO₃=93.5:4:1.25. A fluoride ion conductive material of EXAMPLE 1-9 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-10

In EXAMPLE 1-10, powders of LaF₃, SrF₂, and Na₂CO₃ were mixed in a molar ratio of LaF₃:SrF₂:Na₂CO₃=94:5:0.5. A fluoride ion conductive material of EXAMPLE 1-10 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-11

In EXAMPLE 1-11, powders of LaF₃, SrF₂, and Na₂CO₃ were mixed in a molar ratio of LaF₃:SrF₂:Na₂CO₃=92.5:5:1.25. A fluoride ion conductive material of EXAMPLE 1-11 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-12

In EXAMPLE 1-12, powders of LaF₃, SrF₂, and Na₂CO₃ were mixed in a molar ratio of LaF₃:SrF₂:Na₂CO₃=92:5:1.5. A fluoride ion conductive material of EXAMPLE 1-12 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-13

In EXAMPLE 1-13, powders of LaF₃, SrF₂, and Na₂CO₃ were mixed in a molar ratio of LaF₃:SrF₂:Na₂CO₃=91.5:5:1.75. A fluoride ion conductive material of EXAMPLE 1-13 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-14

In EXAMPLE 1-14, powders of LaF₃, SrF₂, and Na₂CO₃ were mixed in a molar ratio of LaF₃:SrF₂:Na₂CO₃=91:5:2. A fluoride ion conductive material of EXAMPLE 1-14 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-15

In EXAMPLE 1-15, powders of LaF₃, SrF₂, and Na₂CO₃ were mixed in a molar ratio of LaF₃:SrF₂:Na₂CO₃=96.5:2:0.75. A fluoride ion conductive material of EXAMPLE 1-15 was obtained in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-16

In EXAMPLE 1-16, powders of LaF₃, SrF₂, and Na₂CO₃ were mixed in a molar ratio of LaF₃:SrF₂:Na₂CO₃=96:2:1. A fluoride ion conductive material of EXAMPLE 1-16 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-17

In EXAMPLE 1-17, powders of LaF₃, SrF₂, and Na₂CO₃ were mixed in a molar ratio of LaF₃:SrF₂:Na₂CO₃=95.5:2:1.25. A fluoride ion conductive material of EXAMPLE 1-17 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-18

In EXAMPLE 1-18, powders of LaF₃, SrF₂, and Na₂CO₃ were mixed in a molar ratio of LaF₃:SrF₂:Na₂CO₃=94.5:2:1.75. A fluoride ion conductive material of EXAMPLE 1-18 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-19

In EXAMPLE 1-19, powders of LaF₃, SrF₂, and Na₂CO₃ were mixed in a molar ratio of LaF₃:SrF₂:Na₂CO₃=94:2:2. A fluoride ion conductive material of EXAMPLE 1-19 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-20

In EXAMPLE 1-20, powders of LaF₃, SrF₂, and Na₂CO₃ were mixed in a molar ratio of LaF₃:SrF₂:Na₂CO₃=91:6:1.5. A fluoride ion conductive material of EXAMPLE 1-20 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-21

In EXAMPLE 1-21, powders of LaF₃, SrF₂, and Na₂CO₃ were mixed in a molar ratio of LaF₃:SrF₂:Na₂CO₃=90.5:6:1.75. A fluoride ion conductive material of EXAMPLE 1-21 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Example 1-22

In EXAMPLE 1-22, powders of LaF₃, SrF₂, and Na₂CO₃ were mixed in a molar ratio of LaF₃: SrF₂:Na₂CO₃=90:6:2. A fluoride ion conductive material of EXAMPLE 1-22 was prepared in the same manner as in EXAMPLE 1-1 except for this. The composition of the fluoride ion conductive material obtained was as described in Table 1. Furthermore, the fluoride ionic conductivity was measured in the same manner as in EXAMPLE 1-1.

### Comparative Example 1-1

In COMPARATIVE EXAMPLE 1-1, powders of LaF₃ and SrF₂ were mixed in a molar ratio of LaF₃:SrF₂=99:1. A fluoride ion conductive material of COMPARATIVE EXAMPLE 1-1 was prepared in the same manner as in EXAMPLE 1-1 except for this. That is, the fluoride ion conductive material of COMPARATIVE EXAMPLE 1-1 contained no alkali metal elements. The composition of the fluoride ion conductive material obtained was as described in Table 1. Furthermore, the fluoride ionic conductivity was measured in the same manner as in EXAMPLE 1-1.

### Comparative Example 1-2

In COMPARATIVE EXAMPLE 1-2, powders of LaF₃ and SrF₂ were mixed in a molar ratio of LaF₃:SrF₂=98:2. A fluoride ion conductive material of COMPARATIVE EXAMPLE 1-2 was prepared in the same manner as in EXAMPLE 1-1 except for this. That is, the fluoride ion conductive material of COMPARATIVE EXAMPLE 1-2 contained no alkali metal elements. The composition of the fluoride ion conductive material obtained was as described in Table 1. Furthermore, the fluoride ionic conductivity was measured in the same manner as in EXAMPLE 1-1.

### Comparative Example 1-3

In COMPARATIVE EXAMPLE 1-3, powders of LaF₃, SrF₂, and Zr(OH)₄ (manufactured by KISHIDA CHEMICAL CO., LTD.) were mixed in a molar ratio of LaF₃:SrF₂:Zr(OH)₄=91:7:2. Next, the mixture obtained was milled using a planetary ball mill for 5 hours. The milled mixture was heat-treated at 600° C. under a stream of argon gas containing 2 vol % hydrogen. A fluoride ion conductive material of COMPARATIVE EXAMPLE 1-3 was thus prepared. That is, the fluoride ion conductive material of COMPARATIVE EXAMPLE 1-3 contained Zr instead of alkali metal elements. The composition of the fluoride ion conductive material obtained was as described in Table 1. Furthermore, the fluoride ionic conductivity was measured in the same manner as in EXAMPLE 1-1.

### Comparative Example 1-4

In COMPARATIVE EXAMPLE 1-4, powders of LaF₃, SrF₂, and YF₃ (manufactured by FUJIFILM Wako Pure Chemical Corporation) were mixed in a molar ratio of LaF₃:SrF₂:YF₃=94:5:1. A fluoride ion conductive material of COMPARATIVE EXAMPLE 1-4 was prepared in the same manner as in COMPARATIVE EXAMPLE 1-3 except for this. That is, the fluoride ion conductive material of COMPARATIVE EXAMPLE 1-4 contained Y instead of alkali metal elements. The composition of the fluoride ion conductive material obtained was as described in Table 1. Furthermore, the fluoride ionic conductivity was measured in the same manner as in EXAMPLE 1-1.

### Comparative Example 1-5

In COMPARATIVE EXAMPLE 1-5, powders of LaF₃ and Na₂CO₃ were mixed in a molar ratio of LaF₃:Na₂CO₃=97.5:1.25. A fluoride ion conductive material of COMPARATIVE EXAMPLE 1-5 was prepared in the same manner as in EXAMPLE 1-1 except for this. That is, the fluoride ion conductive material of COMPARATIVE EXAMPLE 1-5 contained no alkaline earth metal elements. The composition of the fluoride ion conductive material obtained was as described in Table 1. Furthermore, the fluoride ionic conductivity was measured in the same manner as in EXAMPLE 1-1.

TABLE 1

| | | | | | | Ionic |
|---|---|---|---|---|---|---|
| | | | | | | Conductivity |
| | | La_{1-x-y}M1ₓM2_{y}F_{3-x-2y} | | | | (25° C.) |
| | Composition | M1 | M2 | x | y | [S/cm] |
| EX. 1-1 | La_{0.95}Sr_{0.03}Na_{0.02}F_{2.93} | Sr | Na | 0.03 | 0.02 | 1.2 × 10⁻⁴ |
| EX. 1-2 | La_{0.96}Sr_{0.03}Na_{0.01}F_{2.95} | Sr | Na | 0.03 | 0.01 | 1.0 × 10⁻⁴ |
| EX. 1-3 | La_{0.955}Sr_{0.03}Na_{0.015}F_{2.94} | Sr | Na | 0.03 | 0.015 | 1.0 × 10⁻⁴ |
| EX. 1-4 | La_{0.945}Sr_{0.03}Na_{0.025}F_{2.92} | Sr | Na | 0.03 | 0.025 | 8.2 × 10⁻⁵ |
| EX. 1-5 | La_{0.94}Sr_{0.03}Na_{0.03}F_{2.91} | Sr | Na | 0.03 | 0.03 | 7.2 × 10⁻⁵ |
| EX. 1-6 | La_{0.95}Sr_{0.04}Na_{0.01}F_{2.} | Sr | Na | 0.04 | 0.01 | 6.7 × 10⁻⁵ |
| EX. 1-7 | La_{0.945}Sr_{0.04}Na_{0.015}F_{2.93} | Sr | Na | 0.04 | 0.015 | 7.5 × 10⁻⁵ |
| EX. 1-8 | La_{0.94}Sr_{0.04}Na_{0.02}F_{2.92} | Sr | Na | 0.04 | 0.02 | 6.1 × 10⁻⁵ |
| EX. 1-9 | La_{0.935}Sr_{0.04}Na_{0.025}F_{2.91} | Sr | Na | 0.04 | 0.025 | 6.6 × 10⁻⁵ |
| EX. 1-10 | La_{0.94}Sr_{0.05}Na_{0.01}F_{2.93} | Sr | Na | 0.05 | 0.01 | 8.2 × 10⁻⁵ |
| EX. 1-11 | La_{0.925}Sr_{0.05}Na_{0.025}F_{2.9} | Sr | Na | 0.05 | 0.025 | 6.5 × 10⁻⁵ |
| EX. 1-12 | La_{0.92}Sr_{0.05}Na_{0.03}F_{2.89} | Sr | Na | 0.05 | 0.03 | 6.6 × 10⁻⁵ |
| EX. 1-13 | La_{0.915}Sr_{0.05}Na_{0.035}F_{2.88} | Sr | Na | 0.05 | 0.035 | 5.7 × 10⁻⁵ |
| EX. 1-14 | La_{0.91}Sr_{0.05}Na_{0.04}F_{2.87} | Sr | Na | 0.05 | 0.04 | 4.2 × 10⁻⁵ |
| EX. 1-15 | La_{0.965}Sr_{0.02}Na_{0.015}F_{2.95} | Sr | Na | 0.02 | 0.015 | 6.9 × 10⁻⁵ |
| EX. 1-16 | La_{0.96}Sr_{0.02}Na_{0.02}F_{2.94} | Sr | Na | 0.02 | 0.02 | 7.5 × 10⁻⁵ |
| EX. 1-17 | La_{0.955}Sr_{0.02}Na_{0.025}F_{2.93} | Sr | Na | 0.02 | 0.025 | 9.4 × 10⁻⁵ |
| EX. 1-18 | La_{0.945}Sr_{0.02}Na_{0.035}F_{2.91} | Sr | Na | 0.02 | 0.035 | 4.6 × 10⁻⁵ |
| EX. 1-19 | La_{0.94}Sr_{0.02}Na_{0.04}F_{2.9} | Sr | Na | 0.02 | 0.04 | 4.8 × 10⁻⁵ |
| EX. 1-20 | La_{0.91}Sr_{0.06}Na_{0.03}F_{2.88} | Sr | Na | 0.06 | 0.03 | 5.1 × 10⁻⁵ |
| EX. 1-21 | La_{0.905}Sr_{0.06}Na_{0.035}F_{2.87} | Sr | Na | 0.06 | 0.035 | 4.4 × 10⁻⁵ |
| EX. 1-22 | La_{0.90}Sr_{0.06}Na_{0.04}F_{2.86} | Sr | Na | 0.06 | 0.04 | 4.3 × 10⁻⁵ |
| COMP. EX. 1-1 | La_{0.99}Sr_{0.01}F_{2.99} | Sr | — | 0.01 | 0 | 3.5 × 10⁻⁶ |
| COMP. EX. 1-2 | La_{0.98}Sr_{0.02}F_{2.98} | Sr | — | 0.02 | 0 | 4.0 × 10⁻⁵ |
| COMP. EX. 1-3 | La_{0.91}Sr_{0.07}Zr_{0.02}F_{2.95} | Sr | — | 0.07 | 0 | 7.1 × 10⁻⁷ |
| COMP. EX. 1-4 | La_{0.91}Sr_{0.05}Y_{0.01}F_{2.95} | Sr | — | 0.05 | 0 | 2.1 × 10⁻⁶ |
| COMP. EX. 1-5 | La_{0.975}Na_{0.025}F_{2.95} | — | Na | 0 | 0.025 | 3.0 × 10⁻⁸ |

The fluoride ion conductive materials of EXAMPLES 1-1 to 1-22 had Sr as the alkaline earth metal element M1 and Na as the alkali metal element M2, that is, had a composition represented by La_{1-x-y}SrₓNa_{y}F_{3-x-2y}. The fluoride ion conductive materials of EXAMPLES 1-1 to 1-22 had a higher fluoride ionic conductivity than the fluoride ion conductive materials of COMPARATIVE EXAMPLES 1-1 and 1-2 that did not contain the alkali metal element M2, namely, Na. Furthermore, the fluoride ion conductive materials of EXAMPLES 1-1 to 1-22 had a higher fluoride ionic conductivity than the fluoride ion conductive material of COMPARATIVE EXAMPLE 1-3 containing Zr instead of Na and the fluoride ion conductive material of COMPARATIVE EXAMPLE 1-4 containing Y instead of Na. Furthermore, the fluoride ion conductive materials of EXAMPLES 1-1 to 1-22 had a higher fluoride ionic conductivity than the fluoride ion conductive material of COMPARATIVE EXAMPLE 1-5 that did not contain the alkaline earth metal element M1, namely, Sr. As demonstrated above, the lanthanum fluoride-based materials containing both alkaline earth metal element Sr and alkali metal element Na exhibited an enhanced fluoride ionic conductivity.

### Example 2-1

### Preparation of Fluoride Ion Conductive Material

Powders of LaF₃ (manufactured by Kojundo Chemical Lab. Co., Ltd.), BaF₂ (manufactured by KISHIDA CHEMICAL CO., LTD.), and Na₂CO₃ (manufactured by FUJIFILM Wako Pure Chemical Corporation) were mixed in a molar ratio of LaF₃:BaF₂:Na₂CO₃=96:2:1. Next, the mixture obtained was milled using a planetary ball mill for 5 hours. The milled mixture was heat-treated at 800° C. under a stream of argon gas containing 2 vol % hydrogen. A fluoride ion conductive material having a composition represented by the formula La_{0.96}Ba_{0.02}Na_{0.02}F_{2.94} was thus obtained.

### Evaluation of Fluoride Ionic Conductivity

The fluoride ionic conductivity of the fluoride ion conductive material was measured in the same manner as in EXAMPLE 1-1.

### Example 2-2

In EXAMPLE 2-2, powders of LaF₃, BaF₂, and Na₂CO₃ were mixed in a molar ratio of LaF₃:BaF₂:Na₂CO₃=97:2:0.5. A fluoride ion conductive material of EXAMPLE 2-2 was prepared in the same manner as in EXAMPLE 2-1 except for this. The composition of the fluoride ion conductive material obtained was as described in Table 2. Furthermore, the fluoride ionic conductivity was measured in the same manner as in EXAMPLE 1-1.

### Example 2-3

In EXAMPLE 2-3, powders of LaF₃, BaF₂, and Na₂CO₃ were mixed in a molar ratio of LaF₃:BaF₂:Na₂CO₃=98:1:0.5. A fluoride ion conductive material of EXAMPLE 2-3 was prepared in the same manner as in EXAMPLE 2-1 except for this. The composition of the fluoride ion conductive material obtained was as described in Table 2. Furthermore, the fluoride ionic conductivity was measured in the same manner as in EXAMPLE 1-1.

### Example 2-4

In EXAMPLE 2-4, powders of LaF₃, BaF₂, and Na₂CO₃ were mixed in a molar ratio of LaF₃:BaF₂:Na₂CO₃=97:1:1. A fluoride ion conductive material of EXAMPLE 2-4 was prepared in the same manner as in EXAMPLE 2-1 except for this. The composition of the fluoride ion conductive material obtained was as described in Table 2. Furthermore, the fluoride ionic conductivity was measured in the same manner as in EXAMPLE 1-1.

### Example 2-5

In EXAMPLE 2-5, powders of LaF₃, BaF₂, and Na₂CO₃ were mixed in a molar ratio of LaF₃:BaF₂:Na₂CO₃=96:1:1.5. A fluoride ion conductive material of EXAMPLE 2-5 was prepared in the same manner as in EXAMPLE 2-1 except for this. The composition of the fluoride ion conductive material obtained was as described in Table 2. Furthermore, the fluoride ionic conductivity was measured in the same manner as in EXAMPLE 1-1.

### Comparative Example 2-1

In COMPARATIVE EXAMPLE 2-1, powders of LaF₃ and BaF₂ were mixed in a molar ratio of LaF₃:BaF₂=99:1. A fluoride ion conductive material of COMPARATIVE EXAMPLE 2-1 was prepared in the same manner as in EXAMPLE 2-1 except for this. That is, the fluoride ion conductive material of COMPARATIVE EXAMPLE 2-1 contained no alkali metal elements. The composition of the fluoride ion conductive material obtained was as described in Table 2. Furthermore, the fluoride ionic conductivity was measured in the same manner as in EXAMPLE 1-1.

TABLE 2

| | | | | | | Ionic |
|---|---|---|---|---|---|---|
| | | | | | | Conductivity |
| | | La_{1-x-y}M1ₓM2_{y}F_{3-x-2y} | | | | (25° C.) |
| | Composition | M1 | M2 | x | y | [S/cm] |
| EX. 2-1 | La_{0.96}Ba_{0.02}Na_{0.02}F_{2.94} | Ba | Na | 0.02 | 0.02 | 4.3 × 10⁻⁵ |
| EX. 2-2 | La_{0.97}Ba_{0.02}Na_{0.01}F_{2.96} | Ba | Na | 0.02 | 0.01 | 3.0 × 10⁻⁵ |
| EX. 2-3 | La_{0.98}Ba_{0.01}Na_{0.01}F_{2.97} | Ba | Na | 0.01 | 0.01 | 2.8 × 10⁻⁵ |
| EX. 2-4 | La_{0.97}Ba_{0.01}Na_{0.02}F_{2.95} | Ba | Na | 0.01 | 0.02 | 2.8 × 10⁻⁵ |
| EX. 2-5 | La_{0.96}Ba_{0.01}Na_{0.03}F_{2.93} | Ba | Na | 0.01 | 0.03 | 3.1 × 10⁻⁵ |
| COMP. EX. 2-1 | La_{0.99}Ba_{0.01}F_{2.99} | Ba | — | 0.01 | 0 | 1.7 × 10⁻⁵ |

The fluoride ion conductive materials of EXAMPLES 2-1 to 2-5 had Ba as the alkaline earth metal element M1 and Na as the alkali metal element M2, that is, had a composition represented by La_{1-x-y}BaₓNa_{y}F_{3-x-2y}. The fluoride ion conductive materials of EXAMPLES 2-1 to 2-5 had a higher fluoride ionic conductivity than the fluoride ion conductive material of COMPARATIVE EXAMPLE 2-1 that did not contain the alkali metal element M2, namely, Na. As demonstrated above, the lanthanum fluoride-based materials containing both alkaline earth metal element Ba and alkali metal element Na exhibited an enhanced fluoride ionic conductivity.

### Example 3-1

### Preparation of Fluoride Ion Conductive Material

Powders of LaF₃ (manufactured by Kojundo Chemical Lab. Co., Ltd.), CaF₂ (manufactured by FUJIFILM Wako Pure Chemical Corporation), and K₂CO₃ (manufactured by FUJIFILM Wako Pure Chemical Corporation) were mixed in a molar ratio of LaF₃:CaF₂:K₂CO₃=96:3:0.5. Next, the mixture obtained was milled using a planetary ball mill for 5 hours. The milled mixture was heat-treated at 800° C. under a stream of argon gas containing 2 vol % hydrogen. A fluoride ion conductive material having a composition represented by the formula La_{0.96}Ca_{0.03}K_{0.01}F_{2.95} was thus obtained.

### Evaluation of Fluoride Ionic Conductivity

The fluoride ionic conductivity of the fluoride ion conductive material was measured in the same manner as in EXAMPLE 1-1.

### Example 3-2

In EXAMPLE 3-2, powders of LaF₃, CaF₂, and K₂CO₃ were mixed in a molar ratio of LaF₃:CaF₂:K₂CO₃=94:5:0.5. A fluoride ion conductive material of EXAMPLE 3-2 was prepared in the same manner as in EXAMPLE 3-1 except for this. The composition of the fluoride ion conductive material obtained was as described in Table 3. Furthermore, the fluoride ionic conductivity was measured in the same manner as in EXAMPLE 1-1.

### Comparative Example 3-1

In COMPARATIVE EXAMPLE 3-1, powders of LaF₃ and CaF₂ were mixed in a molar ratio of LaF₃:CaF₂=95:5. A fluoride ion conductive material of COMPARATIVE EXAMPLE 3-1 was prepared in the same manner as in EXAMPLE 3-1 except for this. That is, the fluoride ion conductive material of COMPARATIVE EXAMPLE 3-1 contained no alkali metal elements. The composition of the fluoride ion conductive material obtained was as described in Table 3. Furthermore, the fluoride ionic conductivity was measured in the same manner as in EXAMPLE 1-1.

### Comparative Example 3-2

In COMPARATIVE EXAMPLE 3-2, powders of LaF₃ and K₂CO₃ were mixed in a molar ratio of LaF₃:K₂CO₃=97.5:1.25. A fluoride ion conductive material of COMPARATIVE EXAMPLE 3-2 was prepared in the same manner as in EXAMPLE 3-1 except for this. That is, the fluoride ion conductive material of COMPARATIVE EXAMPLE 3-2 contained no alkaline earth metal elements. The composition of the fluoride ion conductive material obtained was as described in Table 3. Furthermore, the fluoride ionic conductivity was measured in the same manner as in EXAMPLE 1-1.

TABLE 3

| | | | | | | Ionic |
|---|---|---|---|---|---|---|
| | | | | | | Conductivity |
| | | La_{1-x-y}M1ₓM2_{y}F_{3-x-2y} | | | | (25° C.) |
| | Composition | M1 | M2 | x | y | [S/cm] |
| EX. 3-1 | La_{0.96}Ca_{0.03}K_{0.01}F_{2.95} | Ca | K | 0.03 | 0.01 | 8.9 × 10⁻⁶ |
| EX. 3-2 | La_{0.94}Ca_{0.05}K_{0.01}F_{2.93} | Ca | K | 0.05 | 0.01 | 8.1 × 10⁻⁶ |
| COMP. EX. 3-1 | La_{0.95}Ca_{0.05}F_{2.95} | Ca | — | 0.05 | 0 | 6.1 × 10⁻⁶ |
| COMP. EX. 3-2 | La_{0.975}K_{0.025}F_{2.95} | — | K | 0 | 0.025 | 3.0 × 10⁻⁸ |

The fluoride ion conductive materials of EXAMPLES 3-1 and 3-2 had Ca as the alkaline earth metal element M1 and K as the alkali metal element M2, that is, had a composition represented by La_{1-x-y}CaₓK_{y}F_{3-x-2y}. The fluoride ion conductive materials of EXAMPLES 3-1 and 3-2 had a higher fluoride ionic conductivity than the fluoride ion conductive material of COMPARATIVE EXAMPLE 3-1 that did not contain the alkali metal element M2, namely, K. Furthermore, the fluoride ion conductive materials of EXAMPLES 3-1 and 3-2 had a higher fluoride ionic conductivity than the fluoride ion conductive material of COMPARATIVE EXAMPLE 3-2 that did not contain the alkaline earth metal element M1, namely, Ca. As demonstrated above, the lanthanum fluoride-based materials containing both alkaline earth metal element Ca and alkali metal element K exhibited an enhanced fluoride ionic conductivity.

### Example 4

A fluoride shuttle battery was evaluated using the fluoride ion conductive material La_{0.95}Sr_{0.03} Na_{0.02}F_{2.93} of EXAMPLE 1-1 as an electrolyte layer. An evaluation cell was fabricated as follows.

### Preparation of Negative Electrode Mixture

Negative electrode active material Pb_{0.58}Sn_{0.42}F₂ (hereinafter, written as PSF) was prepared as follows. PbF₂ (manufactured by Kojundo Chemical Lab. Co., Ltd.) and SnF₂ (manufactured by Kojundo Chemical Lab. Co., Ltd.) were mixed in a mass ratio of 30:14. Next, the mixture was milled using a planetary ball mill at a rotational speed of 600 rpm for 24 hours.

The negative electrode active material PSF prepared as described above and acetylene black (AB) (manufactured by Denka Company Limited) as a conductive assistant were mixed in a mass ratio of PSF:AB=56:24 and the mixture was milled using a planetary ball mill at a rotational speed of 600 rpm for 10 hours. A negative electrode mixture powder was thus obtained.

### Preparation of Positive Electrode Mixture

The fluoride ion conductive material La_{0.95}Sr_{0.03}Na_{0.02}F_{2.93} of EXAMPLE 1-1, Ag particles (manufactured by Sigma-Aldrich) as a positive electrode active material, and acetylene black (AB) (manufactured by Denka Company Limited) as an electron conductive assistant were mixed in a mass ratio of La_{0.95}Sr_{0.03}Na_{0.02}F_{2.93}:AB:Ag=30.3:67.5:2.2. Next, the mixture obtained was milled using a planetary ball mill at a rotational speed of 200 rpm for 10 hours. A positive electrode mixture powder was thus obtained.

### Fabrication of Evaluation Cell

In a die having a diameter of 10 mm, 10 mg of the positive electrode mixture powder, 150 mg of the powder of the fluoride ion conductive material La_{0.95}Sr_{0.03}Na_{0.02}F_{2.93} of EXAMPLE 1-1, and 30 mg of the negative electrode mixture powder prepared as described above, and further an aluminum foil (manufactured by The Nilaco Corporation, thickness: 10 μm) as a negative electrode current collector were stacked in this order and were compressed. A platinum foil (manufactured by The Nilaco Corporation, thickness: 10 μm) as a positive electrode current collector was placed on top of the layer made of the positive electrode mixture (that is, the positive electrode layer) in the stack. An evaluation cell was thus obtained.

### Comparative Example 4

An evaluation cell was fabricated in the same manner as in EXAMPLE 4, except that the electrolyte layer was fabricated using Ca_{0.1}Ba_{0.5}F₂ instead of La_{0.95}Sr_{0.03}Na_{0.02}F_{2.93.}

### Evaluation of Fluoride Ion Secondary Batteries

The evaluation cells of EXAMPLE 4 and COMPARATIVE EXAMPLE 4 were tested to evaluate charging and discharging of the fluoride shuttle batteries. The charge/discharge evaluation was made using a potentiogalvanostat (SP240 manufactured by Bio-LOGIC). The test was performed by charging and discharging the evaluation cells at a temperature of 25° C., a constant charging current of 5 μA, and a constant discharging current of 5 μA.

FIG. 2 is a graph illustrating the results of the charge/discharge test of the evaluation cell of EXAMPLE 4. In FIG. 2, the abscissa indicates the capacity per weight of the active materials. As illustrated in FIG. 2, the cell of EXAMPLE 4 exhibited charge/discharge capacities even at room temperature. In contrast, the evaluation cell of COMPARATIVE EXAMPLE 4 did not show any charge/discharge capacities.

The results have confirmed that a fluoride shuttle battery using the fluoride ion conductive material of the present disclosure exhibits battery capacities even at room temperature.

The fluoride shuttle battery of the present disclosure is not limited to the embodiments discussed hereinabove, and various modifications and alterations are possible without departing from the scope defined by the claims. For example, the technical features described in the embodiments may be appropriately replaced or combined in order to solve some or all of the problems discussed hereinabove or to achieve some or all of the advantageous effects described hereinabove. Furthermore, technical features that are not described as being essential in the specification may be appropriately omitted.

The fluoride ion conductive material of the present disclosure is expected to be applied to various uses as a material capable of offering fluoride shuttle batteries that can be charged and discharged at room temperature.

What is claimed is:

1. A fluoride ion conductive material comprising:
a compound containing fluorine element, lanthanum element, an alkaline earth metal element, and an alkali metal element,
the compound being represented by compositional formula (1) below:
La_{1-x-y}M1ₓM2_{y}F_{3-x-2y} (1)
wherein
M1 is at least one element selected from alkaline earth metal elements,
M2 is at least one element selected from alkali metal elements,
x satisfies 0<x≤0.3,
y satisfies 0<y≤0.2, and
x+y satisfies 0<x+y≤0.4.

2. The fluoride ion conductive material according to claim 1, wherein
x satisfies 0<x≤0.1.

3. The fluoride ion conductive material according to claim 1, wherein
y satisfies 0<y≤0.1.

4. The fluoride ion conductive material according to claim 1, wherein
M1 includes Sr and
M2 includes Na.

5. The fluoride ion conductive material according to claim 4, wherein
the compositional formula (1) is:
La_{1-x-y}SrₓNa_{y}F_{3-x-2y}
and
x satisfies 0<x≤0.05.

6. The fluoride ion conductive material according to claim 5, wherein
y satisfies 0<y≤0.04.

7. The fluoride ion conductive material according to claim 1, wherein
M1 includes Ba and
M2 includes Na.

8. The fluoride ion conductive material according to claim 7, wherein
the compositional formula (1) is:
La_{1-x-y}BaₓNa_{y}F_{3-x-2y}
and
x satisfies 0<x≤0.05.

9. The fluoride ion conductive material according to claim 8, wherein
y satisfies 0<y≤0.04.

10. The fluoride ion conductive material according to claim 1, wherein
M1 includes Ca and
M2 includes K.

11. The fluoride ion conductive material according to claim 10, wherein
the compositional formula (1) is:
La_{1-x-y}CaₓK_{y}F_{3-x-2y}
and
x satisfies 0<x≤0.05.

12. The fluoride ion conductive material according to claim 11, wherein
y satisfies 0<y≤0.02.

13. A fluoride shuttle battery comprising:
a positive electrode;
a negative electrode; and
an electrolyte layer disposed between the positive electrode and the negative electrode, wherein
at least one selected from the group consisting of the positive electrode, the negative electrode, and the electrolyte layer comprises the fluoride ion conductive material according to claim 1.
